(19) United States
(12) Patent Application Publication
(10) Pub. No.: US 2004/0185281 A1
(43) Pub. Date: Sep. 23, 2004

(54) Polyester color film

(75) Inventors: Chang-Ho Suh, Daegu-si (KR); Ki-Bong Suh, Kyungsangbuk-do (KR); Sang-Pil Kim, Kyungsangbuk-do (KR)

Correspondence Address: ARENT FOX KINTNER PLOTKIN & KAHN, PLLC, 1050 Connecticut Avenue, N.W., Suite 400, Washington, DC, 20036-5339, US

(73) Assignee: TORAY SAEHAN INC.

(21) Appl. No.: 10/388,442

(22) Filed: Mar. 17, 2003

(51) Int. Cl. B32B 33/00

(52) U.S. Cl. 428/480; 428/40.1; 428/200; 428/214

(57) ABSTRACT

The present invention relates to a biaxially stretched, colored polyester film, which can be widely applied in windowpanes of cars and buildings. This colored film comprises a transparent polyester layer A; a colored polyester layer B formed on one surface of the transparent polyester layer A, the colored polyester layer B containing dyes at the amount of 0.01-10% by weight; and a coating layer C rendered adhesive formed on the surface of the colored polyester layer B opposite to the transparent polyester layer A. When the colored film is adhered to the windowpanes of cars and buildings, it exhibits excellent ultraviolet blocking effect and flame retardance while protecting privacy. Also, even when glass is broken by impacts from the outside, the colored film can prevent a broken piece of glass from being scattered. Thus, the colored film is an improved polyester film having high functionality and multi-functionality.

### BACKGROUND OF THE INVENTION

1. Field of the Invention

The present invention relates to a biaxially stretched, colored polyester film for use as a window film, which is attached to the surface of a windowpane of cars, buildings and the like, so that it blocks the transmission of ultraviolet or infrared sunlight and protects privacy, and at the same time, when glass is broken by unexpected impacts, it prevents a broken piece of glass from being scattered so as to prevent secondary accidents.

2. Background of the Related Art

Polyester, mainly polyethylene terephthalate, has excellent physical and chemical properties, and hence, is widely used for polymer-processed products. Particularly, a polyethylene terephthalate film is used as a wide range of industrial materials. Furthermore, it is developed for use as substitutes, such as labels, transfer papers, packing papers, photo papers, imaging papers, and the like. Regarding polymer materials, particularly a window film using a colored polyester film, Korean Patent Registration No. 10-0252022 discloses a method of producing a colored polyester film, which comprises the steps of producing a dyestuff mixture consisting of a dispersion in which at least one disperse dyestuff is dispersed in a thickener solution, the dyestuff mixture having a viscosity of less than 500 centipoise at room temperature; coating a polyester film with the dyestuff mixture to form a coating layer; and heating the resulting film such that the dyestuff migrates from the coating layer into the film. Korean Patent Registration No. 10-0067877 discloses a colored film in which at least one surface of a transparent film has at least one colored adhesive layer, which was colored with a coloring agent, in which the colored adhesive layer contains polyester resins as adhesives and the coloring agent contains a pigment and a polyester-dispersing agent. Moreover, Japanese Patent Application Laid-Open No. Hei 10-230577, U.S. Pat. No. 6,242,081 and Korean Patent Registration No; 10-0082060 disclose a laminated polyester film for pasting on car windows, which comprises at least three layers including intermediate layer(s) being incorporated with a dye. Also, Japanese Patent Application Laid-Open No. 2002-52675, U.S. patent No. 2002/0064650 A1 and Korean Patent Registration No. 10-0013726 disclose an biaxially stretched polyester film for use in windowpanes, which comprises a co-extruded, laminated polyester film of at least three layers including an intermediate layer being incorporated with a dye, and has an antistatic coating of an intrinsic surface resistance of less than 10¹⁴ Ω on at least one surface of the film. Furthermore, Korean Patent Registration No. 10-0145057 discloses a method for producing a biaxially stretched polyester film, in which a polyester resin, which contained a magnesium compound at the amount of 0.1-0.01% by weight and was polycondensed according to a conventional method and also added with an anthraquinone dye as a coloring agent of 100-1,000 ppm relative to the total weight of polyester resins, is mixed with a polyester resin containing no coloring agent, at a predetermined ratio, and the mixture is formed into a film, stretched and thermally treated.

Korean Patent Registration No. 10-068300 discloses a method for producing a solar control film, in which a solution comprising a resin selected from the group consisting of acrylic, vinyl, polyester and polyamide resins and a combination thereof, 0.5-5% by weight of a solvent soluble dye diluted with a solvent, and 1-5% by weight of a benzotriazole or triazine-based ultraviolet absorber, is applied on the section of a polyester film formed with a hard coat layer. Also, Korean Patent Registration No. 10-018537 discloses a method for producing a solar control film, which comprises forming a release layer, an adhesive layer and an antifog layer on a base film, in which a dispersion of a hydrophilic or hydrophobic polymer substance in a polymer binder is applied to form the antifog layer. Furthermore, Korean Patent Registration No. 10-018538 discloses a method for producing a solar control film, which comprises forming a release film, an adhesive film and a hard coating layer on a base film. In this method, adhesives in which an adhesive resin is blended with an infrared absorbing agent that is an organic compound having high absorbing wavelength at the near-infrared range, is applied to form the adhesive film, and a blend of an ultraviolet curable resin with a dye is used to form the hard coating layer.

Generally, the solar control film mainly consists of a polyethylene terephthalate film, blocks sunlight and also is used to enhance safety of the windowpane by strong physical properties of the polyethylene terephthalate film. This solar control film is so-called “safety film”. More concretely, this film is first used to block sunlight. Namely, it reduces sunlight transmission. This increases cooling and heating efficiencies, prevents glaring, protects privacy by a half-mirror effect, and prevents skin aging by ultraviolet blocking.

Second, this control film is used to prevent a secondary accident, which can occur by scattering of a broken piece of glass broken due to strong impacts. Namely, this is achieved by excellent physical properties and adhesive strength of the polyethylene terephthalate film used as a base (support). Third, this film presents various colors by mixing of colors so that it is used for the decorative purpose that increases the appearance quality of cars or buildings and meets various preferences of customers.

The film having various functions as described above is generally called “window film”, which can be divided into a solar control film, a scattering prevention film and an all season window film according to functions thereof. The all season window film is also called the “heat-blocking film”, and attached on the windowpanes so as to block sunlight. Also, it is increasingly used as a film for building windows as interests in energy saving increase. The all season window film comprises a polyethylene terephthalate film of a 25-100 μm thickness, a protective aluminum layer applied on one surface of the film and a pressure sensitive adhesive applied on the other surface of the film. As this all season window film, there are films in which a protective layer is formed on the adhesive layer applied with the pressure sensitive adhesive or other layer, and an ultraviolet absorber or a coloring agent is incorporated into the protective layer. The films having this structure are attached to the inner surface of the windowpanes such that they reflect or absorb sunlight, thereby improving indoor environment. The glass scattering prevention films comprise a pressure sensitive adhesive applied on a transparent polyethylene terephthalate film. After removing an overcoat film, the scattering prevention films are attached on the inner surface of the windowpanes such that even when glass is broken, the broken piece of glass can prevent from being scattered.

The glass scattering prevention films mostly combine a function of the all season window film. Namely, it has a great sunlight blocking effect, and increases heating efficiency, and also prevents a secondary accident upon glass breakdown. In addition, it has a half-mirror effect and improves the appearance of buildings. The solar control film is mainly used as a car window tinting film. An intrinsic purpose of the solar control film was to block light, but its main purpose is being changed into car decoration. Current solar control films are mostly products, which combine the functions of the existing all season window film and glass scattering prevention film. The solar control film can be divided into one for use in cars and one for use in buildings.

The solar control film for cars is used for the decoration purpose to block the transmission of sunlight through the car windows and to protect privacy. Laminated glass for cars is attached to a front windshield of cars, and the solar control film is applied to a side windshield and a back windshield except for a driver's side windshield. For the side and back windshields, reinforced glass other than the laminated glass is used in order to make the escape of passengers easy upon an accident.

The solar control film for buildings is used to increase heating and cooling efficiencies, protect privacy and improve appearance.

### SUMMARY OF THE INVENTION

The present invention provides a colored polyester film for use in building and car windows. The colored film is expected that it will be used as a solar control film in various applications since it has a multi-functionality and high-functionality. In particular, a biaxially stretched, colored polyester film for use in cars and buildings should provide a function as a safety film together with a function to protect privacy.

However, the colored film according to the prior art widely employs thermoplastic resins, which have disadvantages in that they are unstable against ultraviolet rays because of their structure. Also, ultraviolet rays have a high wavelength of 200-400 nm and thus will have a direct effect on decomposition of polymer material by contact with the polymer material.

Thus, in order to minimize ultraviolet decomposition of the polymer material, light stabilizers have been generally added to the polymer material. However, the prior light stabilizers are aromatic compounds, which block the photodecomposition of the polymer material by the structure thereof. Thus, an object of the present invention is to solve various problems of the colored film, such as discoloration, surface splitting, the deterioration of mechanical properties, and the like, by using an ultraviolet stabilizer having excellent performance, which is selected from the group consisting of benzophenone-, benzotriazole-, resorcinol monobenzoate-, salicylate-, hydroxy benzoate-, and formamidine-based ultraviolet absorbers, and hindered amine- and imino ester-based ultraviolet stabilizers, and a combination thereof.

To achieve the above object, in one embodiment, the present invention provides a biaxially stretched, colored polyester film as shown in FIG. 1, which comprises: a transparent polyester layer A; a colored polyester layer B formed on one surface of the transparent polyester layer A, the colored polyester layer B containing dyes-at the amount of 0.01-10% by weight; and a coating layer C rendered adhesive formed on the surface of the colored polyester layer B opposite to the transparent polyester film A.

In the colored polyester film of FIG. 1, at least one of the layers A and B preferably contains an ultraviolet stabilizer at the amount of 0.01-5% by weight.

In the colored polyester film of FIG. 1, at least one of the layer A and B preferably contains a flame retardant at the amount of 0.01-5% by weight.

In the colored polyester film of FIG. 1, at least one of the layers A and B preferably contains the ultraviolet stabilizer and the flame retardant, which are added at the amount of 0.01-5% by weight, respectively.

Preferably, the colored polyester film of FIG. 1 further comprises a pressure sensitive adhesive layer D formed on the other surface of the transparent polyester layer A, as shown in FIG. 2.

Preferably, the colored polyester film of FIG. 1 further comprises a deposition layer E formed on the other surface of the coating layer C, as shown in FIG. 3.

Preferably, the colored polyester film of FIG. 3 further comprises a pressure sensitive adhesive layer D formed on the other surface of the deposition layer E, as shown in FIG. 4.

Preferably, the colored polyester film of FIG. 2 further comprises a transparent film layer F formed on the outer surface of the adhesive layer D, as shown in FIG. 5.

Preferably, the colored polyester film of FIG. 5 further comprises a pressure sensitive adhesive layer D formed on the other surface of the transparent film layer F, as shown in FIG. 6.

Preferably, the colored polyester film of FIG. 4 further comprises a pressure sensitive adhesive layer D and a transparent film layer F sequentially formed on the other surface of the transparent polyester layer A, as shown in FIG. 7.

For a more detailed description of the colored polyester film according to the present invention, FIGS. 1 to 7 schematically show the colored polyester film.

Generally, thermoplastic resins, including polyester, are unstable against ultraviolet rays in view of their structure. Ultraviolet rays have a high wavelength of 200-400 nm, and thus has a direct effect on the decomposition of polymer materials by contact with the polymer materials. In order to minimize the ultraviolet decomposition of the polymer materials, a light stabilizer is generally added to the polymer materials. For the light stabilizer, there are generally used compounds having aromatic structures. These aromatic structures allow the ultraviolet photodecomposition of the polymer materials to be blocked. More concretely, plastic or film products is aged upon outdoor use, mainly due to ultraviolet sunlight. Ultraviolet energy at a wavelength range of 200-400 nm breaks chemical bonds of polymers so as to produces free radicals occurring chain cleavage and crosslinking, etc., thereby causing discoloration, cracking at a product surface, the deterioration of mechanical properties, and the like. This reduction of the physical properties of the polymer material can be hindered by adding an ultraviolet stabilizer to a polymer-processed product or a polymer film. Namely, the ultraviolet stabilizer means a compound, which prevents or inhibits a physical and chemical procedure causing the reduction of the physical properties caused by light. The reaction of the physical property reduction caused by ultraviolet rays is reaction occurring in the presence of air oxygen, and more specifically, oxidation reaction, which is initiated and accelerated by ultraviolet rays. Actions of the ultraviolet stabilizer include ultraviolet absorption, ultraviolet blocking and thus the prevention of internal decomposition, and the absorption of reactive radicals. Generally, a suitable combination of an antioxidant and an ultraviolet stabilizer is most ideal. The stabilization mechanism of the ultraviolet stabilizer is divided into the following two mechanisms.

First, the ultraviolet stabilizer either blocks or selectively absorbs ultraviolet energy to emit it energy in other energy forms harmless to a polymer material, or suppresses chromophores of an activated polymer material to retard the initiation of photodecomposition reaction. This ultraviolet stabilizer includes a light blocker, an ultraviolet absorber, and a quencher.

Second, the ultraviolet stabilizer is reacted with free radicals or hydroperoxides upon photodecomposition to stop the production of free radicals and to decompose the peroxides, thereby retarding the photodecomposition reaction. This ultraviolet stabilizer includes a radical scavenger, a peroxide decomposing agent, and a hindered amine stabilizer. The fundamental mechanism of the ultraviolet absorption is to absorb an ultraviolet wavelength harmful to a resin to emit it in heat or other stable forms. In order that the ultraviolet absorption is made with high ultraviolet absorption, the ultraviolet stabilizer must be a compound having a very stable molecular structure. This is because it tends to take place a reaction by itself due to high energy level when the absorbed light energy is emitted in the other forms.

Ultraviolet absorbers, which are generally used, include hydroxybenzophenon- and hydroxybenzotriazole-based ultraviolet absorbers. The hydroxybenzophenone-based ultraviolet stabilizer is used in various applications due to its excellent compatibility with resins, but is inferior to the hydroxybenzotriazole-ultraviolet stabilizer in ultraviolet absorbing capacity at wavelengths longer than 340 nm. The benzotriazole-based ultraviolet stabilizer has an ultraviolet-absorbing capacity over a wide wavelength range, and is mainly used in colorless products and high quality products. In addition, there are ultraviolet absorbers, such as resorcinol monobenzoate-, salicylate-, hydroxybenzoate- and formamidine-based ultraviolet absorbers. Furthermore, a free radical scavenger is to capture free radicals, as media of the oxidation reaction, unlike removal of the energy source as described above. A method, which makes resins to have a stability against ultraviolet rays by the free radical scavenger, was developed late, and it seems that this method was not examined until a phenone-based antioxidant as a free radical activity inhibitor was found to be not so much effective in ultraviolet oxidation reaction. Typical ultraviolet stabilizers using the free radical scavenger include hindered-amine light stabilizer (HALS), which is easily oxidized so that it is converted into a nitroxy radical, and reacted with a polymer radical to produce hydroxylamine ether. Unlike the ultraviolet absorbers, the hindered amine light stabilizer has an excellent surface protection action and can be applied even in products of a small thickness so that its demand gradually increases with the development of specific grades. In addition, as the ultraviolet stabilizer, there may be used cyclic imino ester compounds having an aromatic nucleus, two carbon atoms of which forms a part of the imino ester ring, as described in U.S. Pat. No. 4,446,262. The imino ester-based ultraviolet stabilizer has an excellent thermal stability and also is stable against oxidation.

Meanwhile, although the thermoplastic resins, including polyester, are widely used, they have low thermal resistance in view of their structure. Since the resins are thermally decomposed by the application of heat while emitting toxic gas, efforts to prevent these phenomena are required. In addition, if a film that is usually used is rendered flame retardant, it is particularly beneficial. Flame retardants, which retard flammability, include additive-type or reactive-type flame retardants, such as alumina trihydrate-, halogen-, phosphorus-, and halogenated phosphorus-based flame retardants. The alumina trihydrate-based flame retardant needs to be added at large amounts for sufficient inhibition of flammability. Since the alumina trihydrate-based flame retardant is inexpensive and does not cause incomplete combustion, it has an effect of reducing the generation of smoke or toxic gas. As well known, halogen compounds are effective in giving a flame retardant property, and have an excellent effect in the order of I>Br>Cl>F.

Although the iodine compound is the most effective flame retardant, it is expensive and has a thermal stability insufficient to apply in the resins. For this reason, the bromine and chlorine compounds are mainly used. Examples of the additive-type flame retardant include chlorinated paraffins, chlorinated cycloaliphatics, brominated aromatics, brominated aromatic polymers, and the like. Examples of the reactive-type flame retardant include chlorendic acid, chlorendic anhydride, tetrabromobisphenol, tetrabromophthalic anhydride, and the like.

Examples of the phosphorus-based flame retardant include phosphoric acid- and phosphate-flame retardants. Concrete examples of the phosphorus-based flame retardant include ammonium phosphate-, ammonium phosphate polymer-, alkyl phosphate-, alkyl phosphonate-, triallyl phosphate-, halogenated alkyl phosphonate-, halogenated alkyl phosphate-, phosphonium salt-, and phosphogen-based flame retardants. In addition, various compounds, including antimony oxide compounds such as antimony pentoxide, boron compounds such as boronic acid and boronate, and the like, may be also be applied to control the flammability of the polymer film.

The present invention provides a colored polyester film for use in buildings and cars. The colored film is expected that it will be used as a solar control film in various applications since it has a multi-functionality and high-functionality.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a cross-sectional view illustrating a fundamental structure of a colored polyester film according to the present invention;

FIG. 2 is a cross-sectional view illustrating a colored film according to a first embodiment of the present invention;

FIG. 3 is a cross-sectional view illustrating a colored film according to another embodiment of the present invention;

FIG. 4 is a cross-sectional view illustrating a colored film according to another embodiment of the present invention;

FIG. 5 is a cross-sectional view illustrating a colored film according to still another first embodiment of the present invention;

FIG. 6 is a cross-sectional view illustrating a colored film according to yet another embodiment of the present invention; and

FIG. 7 is a cross-sectional view illustrating a colored film according to still another embodiment of the present invention.

### DETAILED DESCRIPTION OF THE PREFERRED EMBODIMENT

Hereinafter, a biaxially stretched, colored polyester film according to the present invention will be described in detail with reference to the accompanying drawings.

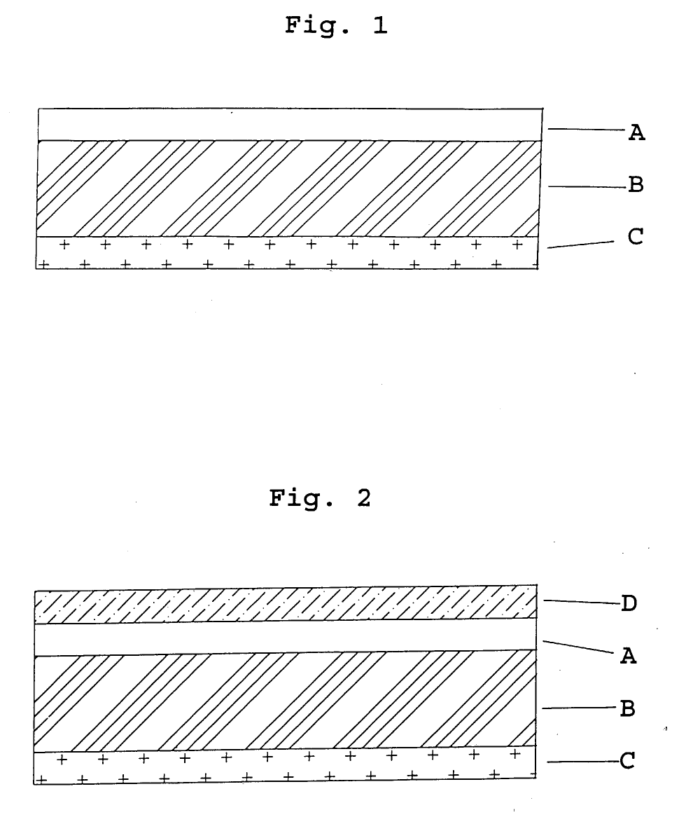

As shown in FIG. 1, the biaxially stretched, colored polyester film according to the present invention comprises: a transparent polyester layer A; a colored polyester layer B formed on one surface of the transparent polyester layer A, the colored polyester layer B containing dyes at the amount of 0.01-10% by weight; and a coating layer C rendered adhesive formed on the other surface of the colored polyester layer B.

In the colored polyester film of FIG. 1, at least one of the layers A and B preferably contains an ultraviolet stabilizer at the amount of 0.01-5% by weight.

In the colored polyester film of FIG. 1, at least one of the layer A and B preferably contains a flame retardant at the amount of 0.01-5% by weight.

In the colored polyester film of FIG. 1, at least one of the layers A and B preferably contains the ultraviolet stabilizer and the flame retardant, which are added at the amount of 0.01-5% by weight, respectively.

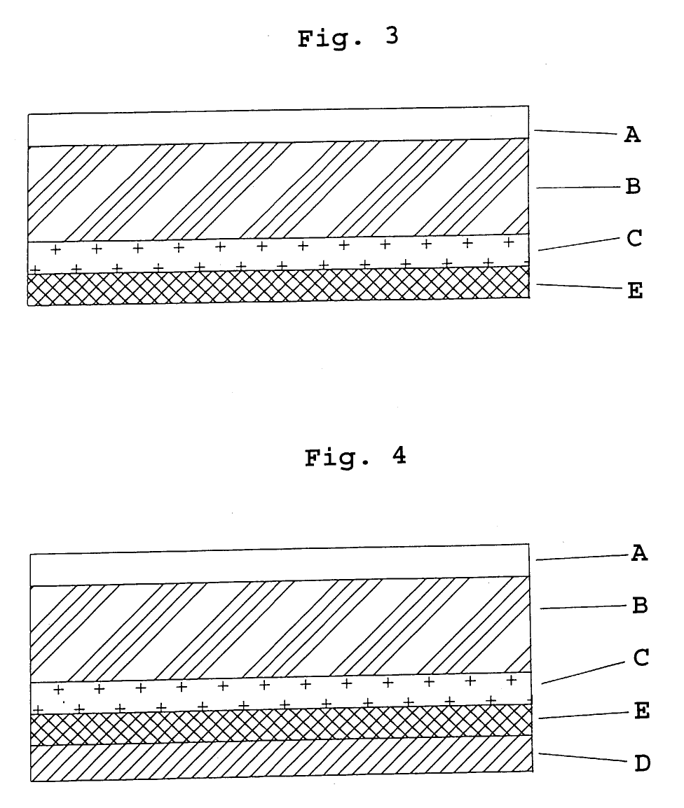

As shown in FIG. 2, the colored polyester film of FIG. 1 further comprises a pressure sensitive adhesive layer D formed on the other surface of the transparent polyester layer A.

As shown in FIG. 3, the colored polyester film of FIG. 1 further comprises a deposition layer E formed on the other surface of the coating layer C.

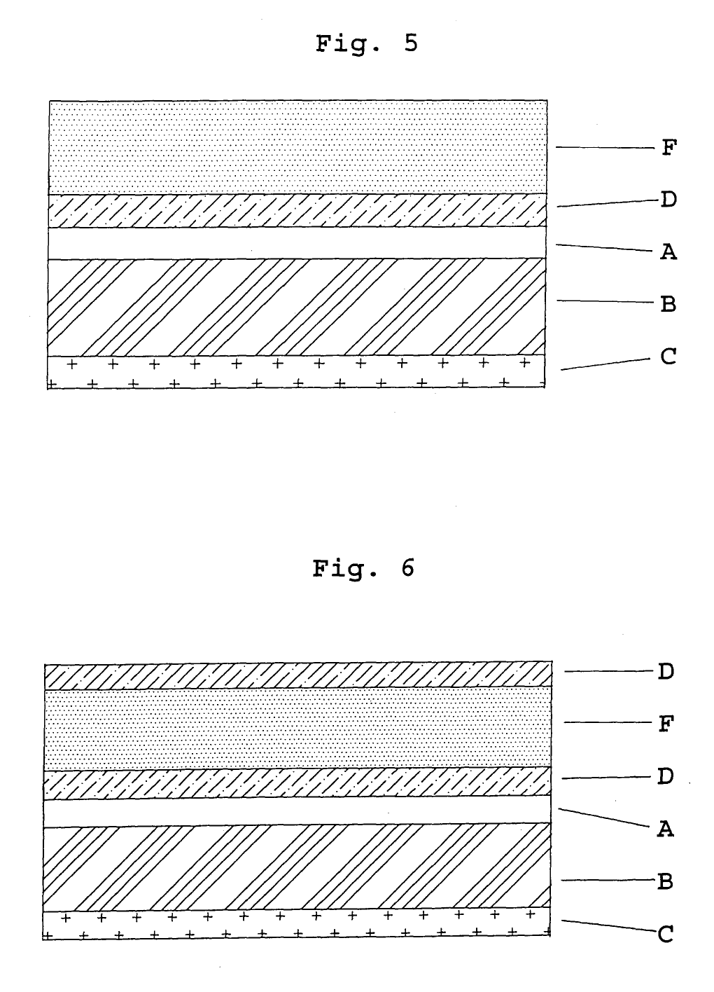

As shown in FIG. 4, the colored polyester film of FIG. 3 further comprises a pressure sensitive adhesive layer D formed on the other surface of the deposition layer E.

As shown in FIG. 5, the colored polyester film of FIG. 2 further comprises a transparent film layer F formed on the outer surface of the adhesive layer D.

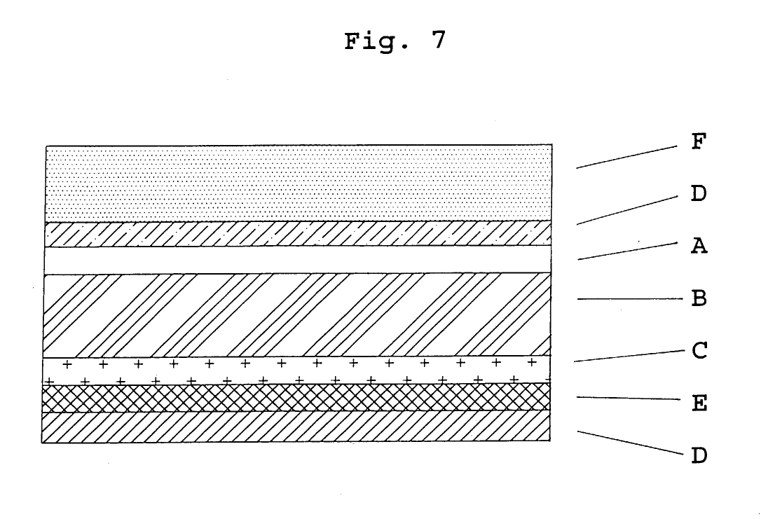

As shown in FIG. 6, the colored polyester film of FIG. 5 further comprises a pressure sensitive adhesive layer D formed on the other surface of the transparent film layer F.

As shown in FIG. 7, the colored polyester film of FIG. 4 further comprises a pressure sensitive adhesive layer D and a transparent film layer F sequentially formed on the other surface of the transparent polyester layer A.

Examples of the ultraviolet stabilizer, which can be used in the colored film of the present invention, include benzophenone-, benzotriazole-, resorcinol monobenzoate-, salicylate-, hydroxy benzoate-, and formamidine-based ultraviolet absorbers, and hindered amine- and imino ester-based ultraviolet stabilizers, and a combination thereof. Examples of the flame retardant, which can be used in the colored film of the present invention, include additive-type or reactive-type flame retardants, such as alumina trihydrate-, halogen-, phosphorus- and halogenated phosphorus-based flame retardants, and a combination thereof.

In the present invention, in order to adjust surface characteristics of the film, the surface roughness of the film is inputted using a co-extrusion technique and an inorganic particle design technique, thereby achieving the desired gloss level.

Generally, particles used in giving functions the film by loading the film with additives, include inorganic particles and organic compounds. The inorganic particles can be divided into particles of a one-dimensional shape, particles of a two-dimensional shape, and particles of a three-dimensional shape, according to the shape thereof. The particles of the one-dimensional shape include wollastonites, glass fibers, carbon fibers, aramid fibers, and the like. The particles of the two-dimensional shape include talc, mica, and the like, and the particles of the three-dimensional shape include calcium carbonates, silicates, and the like. Also, the organic compounds include flame retardants, infrared stabilizers, organic dyes, and the like. Among these organic compounds, the organic dyes are unsuitable for use in polyester films, and thus have been limited in their use.

According to the present invention, in order for a colored polyester film to have suitable gloss and turbidity (haze), inorganic particles having an average particle size of 0.05-5 μm was added to at least one layer of the transparent layer A and the colored layer B. The inorganic particle layer was formed to a thickness of 1-10 μm. As the inorganic particles, titanium dioxides (silica) were most preferably added. The inorganic particles was most preferably used at the amount of 0.01-1% by weight.

In measurement of main physical properties in the present invention, turbidity (haze) was measured according to ASTM D 1003, and adhesion was measured according to ASTM D 3359.

Adhesion to ink was rated according to adhesion test ratings of ASTM D 3359, Method B (cross-cut tape test). Namely, it was rated on a scale of 5B to 0B as described below.

5B: The edges of the cuts are completely smooth; none of the squares of the lattice is detached.

4B: Small flakes of the coating are detached at intersections of cuts; less than 5% of the area is affected.

3B: Small flakes of the coating are detached along edges and at intersections of cuts. The area affected is 5% to 15% of the lattice.

2B: The coating has flaked along the edges and on parts of the squares. The area affected is 15% to 35% of the lattice.

1B: The coating has flaked along the edges of cuts in large ribbons and whole squares have detached. The area affected is 35% to 65% of the lattice.

0B: Flaking and detachment worse than Grade 1B. The area affected is greater than 65% of the lattice.

Ultraviolet stability of the film was estimated by an average ultraviolet blockage at a 310-380 nm wavelength range using an ultraviolet spectrometer. The average ultraviolet blockage was calculated according to the following equation (1):

Average UV blockage=100-{(T₁+T₂)×0.36+(T₃+T₄)×0.14} (1)

where T₁ is maximum transmission at a 310-360 nm wavelength range, T₂ is minimum transmission at a 310-360 nm wavelength range, T₃ is transmission at a 360 nm wavelength, and T₄ is transmission at a 380 nm wavelength. The flame retardant property of the film was estimated by an LOI value, which represents the minimum oxygen concentration (volume%) required for ignition/combustion of the film. A higher LOI value shows a lower flammability. A sample of a 14 cm×6 cm×25 μm size was measured for its LOI values using a L01 flammability unit. The flow rate of oxygen and nitrogen was controlled such that the total flow rate of oxygen and nitrogen was always maintained at 18 liters/minute and the ratio of oxygen to nitrogen was changed. Initial oxygen concentration was set to 25%, and the sample was ignited at its upper portion using a butane combustor. If the sample was burnt badly, the oxygen concentration was increased. On the other hand, if combustion of the sample occurred, the oxygen concentration was reduced.

The present invention will hereinafter be described in further detail by examples and comparative examples. It should however be borne in mind that the present invention is not limited to or by the examples.

### EXAMPLE 1

The raw material PM₁ used in this example is polyethylene terephthalate containing no particles and having an intrinsic viscosity of 0.65 dl/g. The raw material PM₂ is polyethylene terephthalate containing 1% by weight of silicon dioxide having an average particle size of 2 μm. The raw material PM₃ is polyethylene terephthalate containing Clariant's dye Red GFP, Blue RBL and Yellow GG at the amount of 5.5% by weight, 3.5% by weight and 1.0% by weight, respectively. The raw material PM₄ is polyethylene terephthalate containing 7.0% by weight of an imino ester-based ultraviolet stabilizer. The raw material PM₅ is polyethylene terephthalate containing 0.7% by weight of a phosphorus-based flame retardant. The raw materials PM₁, PM₂, PM₃, PM₄ and PM₅ were mixed and dried at the weight ratio indicated in Table 1, laminated in the form of a three-layered structure in a feed block, extruded through a co-extrusion die, and cooled in a casting drum, thereby producing a sheet. The sheet was 3.0-fold stretched in the longitudinal direction at a temperature of 75-130° C., and then coated with an aqueous dispersion containing 2.0% by weight of a water-soluble acrylic emulsion, using an inline coater. Next, the resulting sheet was 3.3-fold stretched in the transverse direction at a temperature of 90-145° C., after which it was thermally treated at a temperature of 215-235° C., thereby obtaining a film having an average thickness of 25 μm. In the produced film, the thickness of each of the layers A, B and C was 2 μm, 22.95 μm and 0.05 μm, respectively.

TABLE 1

| | | Layer | | | | | | |
|---|---|---|---|---|---|---|---|---|
| | | thickness | Contents (wt %) | | | | | |
| Examples | Layers | (μm) | PM₁ | PM₂ | PM₃ | PM₄ | PM₅ | Remarks |
| Example 1 | A | 2 | 96 | 4 | 0 | 0 | 0 | Laminated |
| | B | 22.95 | 80 | 0 | 20 | 0 | 0 | |
| | C | 0.05 | — | — | — | — | — | |
| Example 2 | A | 2 | 97 | 3 | 0 | 0 | 0 | Laminated |
| | B | 22.95 | 80 | 0 | 20 | 0 | 0 | |
| | C | 0.05 | — | — | — | — | — | |
| Example 3 | A | 4 | 93 | 7 | 0 | 0 | 0 | Laminated |
| | B | 20.95 | 80 | 0 | 20 | 0 | 0 | |
| | C | 0.05 | — | — | — | — | — | |
| Example 4 | A | 4 | 94 | 6 | 0 | 0 | 0 | Laminated |
| | B | 20.95 | 80 | 0 | 20 | 0 | 0 | |
| | C | 0.05 | — | — | — | — | — | |
| Example 5 | A | 2 | 96 | 4 | 0 | 0 | 0 | Laminated |
| | B | 22.95 | 70 | 0 | 20 | 10 | 0 | |
| | C | 0.05 | — | — | — | — | — | |
| Example 6 | A | 2 | 97 | 3 | 0 | 0 | | Laminated |
| | B | 22.95 | 70 | 0 | 20 | 10 | | |
| | C | 0.05 | — | — | — | — | | |
| Example 7 | A | 4 | 93 | 7 | 0 | 0 | 0 | Laminated |
| | B | 20.95 | 70 | 0 | 20 | 10 | 0 | |
| | C | 0.05 | — | — | — | — | — | |
| Example 8 | A | 4 | 94 | 6 | 0 | 0 | 0 | Laminated |
| | B | 20.95 | 70 | 0 | 20 | 10 | 0 | |
| | C | 0.05 | — | — | — | — | — | |
| Example 9 | A | 2 | 96 | 4 | 0 | 0 | 0 | Laminated |
| | B | 22.95 | 65 | 0 | 20 | 0 | 15 | |
| | C | 0.05 | — | — | — | — | — | |
| Example 10 | A | 2 | 97 | 3 | 0 | 0 | 0 | Laminated |
| | B | 22.95 | 65 | 0 | 20 | 0 | 15 | |
| | C | 0.05 | — | — | — | — | — | |
| Example 11 | A | 4 | 93 | 7 | 0 | 0 | 0 | Laminated |
| | B | 20.95 | 65 | 0 | 20 | 0 | 15 | |
| | C | 0.05 | — | — | — | — | — | |
| Example 12 | A | 4 | 94 | 6 | 0 | 0 | 0 | Laminates |
| | B | 20.95 | 65 | 0 | 20 | 0 | 15 | |
| | C | 0.05 | — | — | — | — | — | |

### EXAMPLE 2

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 2 μm, 22.95 μm and 0.05 μm, respectively.

### EXAMPLE 3

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 4 μm, 20.95 μm and 0.05 μm, respectively.

### EXAMPLE 4

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 4 μm, 20.95 μm and 0.05 μm, respectively.

### EXAMPLE 5

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 2 μm, 22.95 μm and 0.05 μm, respectively.

### EXAMPLE 6

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 2 μm, 22.95 μm and 0.05 μm, respectively.

### EXAMPLE 7

The raw materials PM₁, PM₂, PM₃, PM₄ and PM₅ were mixed and dried at the weight ratio indicated in Table 1, and then treated in the same manner as described in Example. 1, thereby obtaining a film having an average thickness of 25 μm. In the produced film, the thickness of each of the layers A, B and C was 4 μm, 20.95 μm and 0.05 μm, respectively.

### EXAMPLE 8

The raw materials PM₁, PM₂, PM₃₁ PM₄ and PM, were mixed and dried at the weight ratio indicated in Table 1, and then treated in the same manner as described in Example 1, thereby obtaining a film having an average thickness of 25 μm. In the produced film, the thickness of each of the layers A, B and C was 4 μm, 20.95 μm and 0.05 μm, respectively.

### EXAMPLE 9

The raw materials PM₁, PM₂, PM₃, PM₄ and PM, were mixed and dried at the weight ratio indicated in Table 1, and then treated in the same manner as described in Example 1, thereby obtaining a film having an average thickness of 25 μm. In the produced film, the thickness of each of the layers A, B and C was 2 μm, 22.95 μm and 0.05 μm, respectively.

### EXAMPLE 10

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 2 μm, 22.95 μm and 0.05 μm, respectively.

### EXAMPLE 11

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 4 μm, 20.95 μm and 0.05 μm, respectively.

### EXAMPLE 12

The raw materials PM₁, PM₂, PM₃, PM₄ and PM₅ were mixed and dried at the weight ratio indicated in Table 1, and then treated in the same manner as described in Example 1, thereby obtaining a film having an average thickness of 25 μm. In the produced film, the thickness of each of the layers A, B and C was 4 μm, 20.95 μm and 0.05 μm, respectively.

TABLE 2

| | | | Contents (wt %) | | | | | |
|---|---|---|---|---|---|---|---|---|
| Examples | Layers | Layer thickness (μm) | PM₁ | PM₂ | PM₃ | PM₄ | PM₅ | Remarks |
| Example 13 | A | 2 | 96 | 4 | 0 | 0 | 0 | Laminated |
| | B | 22.95 | 55 | 0 | 20 | 10 | 15 | |
| | C | 0.05 | — | — | — | — | — | |
| Example 14 | A | 2 | 97 | 3 | 0 | 0 | 0 | Laminated |
| | B | 22.95 | 55 | 0 | 20 | 10 | 15 | |
| | C | 0.05 | — | — | — | — | — | |
| Example 15 | A | 4 | 93 | 7 | 0 | 0 | 0 | Laminated |
| | B | 20.95 | 55 | 0 | 20 | 10 | 15 | |
| | C | 0.05 | — | — | — | — | — | |
| Example 16 | A | 4 | 94 | 6 | 0 | 0 | 0 | Laminated |
| | B | 20.95 | 55 | 0 | 20 | 10 | 15 | |
| | C | 0.05 | — | — | — | — | — | |
| Comparative | — | 25 | 72 | 8 | 20 | 0 | 0 | Single |
| Example 1 | | | | | | | | layer |
| Comparative | — | 25 | 78 | 2 | 20 | 0 | 0 | Single |
| Example 2 | | | | | | | | layer |

### EXAMPLE 13

The raw materials PM₁, PM₂, PM₃, PM₄ and PM₅ were mixed and dried at the weight ratio indicated in Table 2 above, and then treated in the same manner as described in Example 1, thereby obtaining a film having an average thickness of 25 μm. In the produced film, the thickness of each of the layers A, B and C was 2 μm, 22.95 μm and 0.05 μm, respectively.

### EXAMPLE 14

The raw materials PM₁, PM₂, PM₃, PM₄ and PM₅ were mixed and dried at the weight ratio indicated in Table 2 above, and then treated in the same manner as described in Example 1, thereby obtaining a film having an average thickness of 25 μm. In the produced film, the thickness of each of the layers A, B and C was 2 μm, 22.95 μm and 0.05 μm, respectively.

### EXAMPLE 15

The raw materials PM₁, PM₂, PM₃1 PM₄ and PM₅ were mixed and dried at the weight ratio indicated in Table 2 above, and then treated in the same manner as described in Example 1, thereby obtaining a film having an average thickness of 25 μm. In the produced film, the thickness of each of the layers A, B and C was 4 μm, 20.95 μm and 0.05 μm, respectively.

### EXAMPLE 16

The raw materials PM₁, PM₂, PM₃, PM₄ and PM₅ were mixed and dried at the weight ratio indicated in Table 2 above, and then treated in the same manner as described in Example 1, thereby obtaining a film having an average thickness of 25 μm. In the produced film, the thickness of each of the layers A, B and C was 4 μm, 20.95 μm and 0.05 μm, respectively.

### COMPARATIVE EXAMPLE 1

The raw material PM₁ used in this comparative example is polyethylene terephthalate containing no particles and having an intrinsic viscosity of 0.65 dl/g. The raw material PM₂ is polyethylene terephthalate containing 5% by weight of silicon dioxide having an average particle size of 4 μm. The raw material PM₃ is polyethylene terephthalate containing Clariant's dyes Red GFP, Blue RBL and Yellow GG at the amount of 5.5% by weight, 3.5% by. weight and 1.0% by weight, respectively. The raw materials PM₁, PM₂ and PM3 were mixed and dried at the weight ratio indicated in Table 2 above, extruded in the form of a single layer, and cooled in a casting drum, thereby producing a sheet. The sheet was 3.0-fold stretched in the longitudinal direction at a temperature of 75-130° C., and then 3.3-fold stretched in the transverse direction at a temperature of 90-145° C. Then, the stretched sheet was thermally treated at a temperature of 215-235° C., thereby obtaining a film having an average thickness of 25 μm.

### COMPARATIVE EXAMPLE 2

The raw materials PM₁, PM₂ and PM₃ were mixed and dried at the weight ratio indicated in Table 2 above, and then treated in the same manner as described in Example 1, thereby obtaining a film having an average thickness of 25 μm.

Table 3 below shows silica contents, glosses, turbidities, ultraviolet blockages and LOI values measured on the films produced according to Examples of the present invention and Comparative Examples. Table 4 below shows the results of ink adhesion tests conducted on the films produced according to Examples of the present invention and Comparative Examples.

TABLE 3

| | | Layer | Silica | | UV | | |
|---|---|---|---|---|---|---|---|
| | | thickness | content | Turbidity | blockage | LOI | |
| Examples | Layers | (μm) | (wt %) | (%) | (vol %) | (vol %) | Remarks |
| Example 1 | A | 2 | 0.04 | 0.4 | 40 | 20 | Laminated |
| | B | 22.95 | 0 | | | | |
| | C | 0.05 | — | | | | |
| Example 2 | A | 2 | 0.03 | 0.3 | 39 | 21 | Laminated |
| | B | 22.95 | 0 | | | | |
| | C | 0.05 | — | | | | |
| Example 3 | A | 4 | 0.07 | 0.6 | 39 | 20 | Laminated |
| | B | 20.95 | 0 | | | | |
| | C | 0.05 | — | | | | |
| Example 4 | A | 4 | 0.06 | 0.5 | 38 | 21 | Laminated |
| | B | 20.95 | 0 | | | | |
| | C | 0.05 | — | | | | |
| Example 5 | A | 2 | 0.04 | 0.4 | 99 | 20 | Laminated |
| | B | 22.95 | 0 | | | | |
| | C | 0.05 | — | | | | |
| Example 6 | A | 2 | 0.03 | 0.3 | 99 | 20 | Laminated |
| | B | 22.95 | 0 | | | | |
| | C | 0.05 | — | | | | |
| Example 7 | A | 4 | 0.07 | 0.6 | 99 | 21 | Laminated |
| | B | 20.95 | 0 | | | | |
| | C | 0.05 | — | | | | |
| Example 8 | A | 4 | 0.06 | 0.5 | 99 | 21 | Laminated |
| | B | 20.95 | 0 | | | | |
| | C | 0.05 | — | | | | |
| Example 9 | A | 2 | 0.04 | 0.4 | 38 | 27 | Laminated |
| | B | 22.95 | 0 | | | | |
| | C | 0.05 | — | | | | |
| Example 10 | A | 2 | 0.03 | 0.3 | 39 | 27 | Laminated |
| | B | 22.95 | 0 | | | | |
| | C | 0.05 | — | | | | |
| Example 11 | A | 4 | 0.07 | 0.6 | 40 | 28 | Laminated |
| | B | 20.95 | 0 | | | | |
| | C | 0.05 | — | | | | |
| Example 12 | A | 4 | 0.06 | 0.5 | 41 | 26 | Laminated |
| | B | 20.95 | 0 | | | | |
| | C | 0.05 | — | | | | |
| Example 13 | A | 2 | 0.04 | 0.4 | 99 | 27 | Laminated |
| | B | 22.95 | 0 | | | | |
| | C | 0.05 | — | | | | |
| Example 14 | A | 2 | 0.03 | 0.3 | 99 | 27 | Laminated |
| | B | 22.95 | 0 | | | | |
| | C | 0.05 | — | | | | |
| Example 15 | A | 4 | 0.07 | 0.6 | 99 | 28 | Laminated |
| | B | 20.95 | 0 | | | | |
| | C | 0.05 | — | | | | |
| Example 16 | A | 4 | 0.06 | 0.5 | 99 | 26 | Laminated |
| | B | 20.95 | 0 | | | | |
| | C | 0.05 | — | | | | |
| Comparative | — | 25 | 0.08 | 4 | 40 | 20 | Single layer |
| Example 1 | | | | | | | |
| Comparative | — | 25 | 0.02 | 1 | 38 | 20 | Single layer |
| Example 2 | | | | | | | |

TABLE 4

| | | Ink adhesion | | | | | | | | | |
|---|---|---|---|---|---|---|---|---|---|---|---|
| | | | | | Solvent | | Solvent | | | | |
| | | Binder | Solvent | Binder | TOL/ | Binder | TOL/ | Binder | Solvent | Binder | Solvent |
| Examples | Layers | AC | EA | NC | MEK | EVA | IPA/EA | VC-VA | MEK | CAB | MEK |

| | | | | | | |
|---|---|---|---|---|---|---|
| Example 1 | A | 1B | 1B | 1B | 1B | 1B |
| | B | — | — | — | — | — |
| | C | 4B | 4B | 5B | 4B | 5B |
| Example 2 | A | 1B | 1B | 1B | 1B | 1B |
| | B | — | — | — | — | — |
| | C | 4B | 4B | 5B | 4B | 5B |
| Example 3 | A | 1B | 1B | 1B | 1B | 1B |
| | B | — | — | — | — | — |
| | C | 4B | 4B | 5B | 4B | 5B |
| Example 4 | A | 1B | 1B | 1B | 1B | 1B |
| | B | — | — | — | — | — |
| | C | 4B | 4B | 5B | 4B | 5B |
| Example 5 | A | 1B | 1B | 1B | 1B | 1B |
| | B | — | — | — | — | — |
| | C | 4B | 4B | 5B | 4B | 5B |
| Example 6 | A | 1B | LB | 1B | 1B | 1B |
| | B | — | — | — | — | — |
| | C | 4B | 4B | 5B | 4B | 5B |
| Example 7 | A | 1B | LB | 1B | 1B | 1B |
| | B | — | — | — | — | — |
| | C | 4B | 4B | 5B | 4B | 5B |
| Example 8 | A | 1B | LB | 1B | 1B | 1B |
| | B | — | — | — | — | — |
| | C | 4B | 4B | 5B | 4B | 5B |
| Example 9 | A | 1B | LB | 1B | 1B | 1B |
| | B | — | — | — | — | — |
| | C | 4B | 4B | 5B | 4B | 5B |
| Example 10 | A | 1B | LB | 1B | 1B | 1B |
| | B | — | — | — | — | — |
| | C | 4B | 4B | 5B | 4B | 5B |
| Example 11 | A | 1B | LB | 1B | 1B | 1B |
| | B | — | — | — | — | — |
| | C | 4B | 4B | 5B | 4B | 5B |
| Example 12 | A | 1B | LB | 1B | 1B | 1B |
| | B | — | — | — | — | — |
| | C | 4B | 4B | 5B | 4B | 5B |
| Example 13 | A | 1B | LB | 1B | 1B | 1B |
| | B | — | — | — | — | — |
| | C | 4B | 4B | 5B | 4B | 5B |
| Example 14 | A | 1B | LB | 1B | 1B | 1B |
| | B | — | — | — | — | — |
| | C | 4B | 4B | 5B | 4B | 5B |
| Example 15 | A | 1B | LB | 1B | 1B | 1B |
| | B | — | — | — | — | — |
| | C | 4B | 4B | 5B | 4B | 5B |
| Example 16 | A | 1B | LB | 1B | 1B | 1B |
| | B | — | — | — | — | — |
| | C | 4B | 4B | 5B | 4B | 5B |
| Comparative | — | 1B | 1B | 1B | 1B | 1B |
| Example 1 | | | | | | |
| Comparative | — | 1B | 1B | 1B | 1B | 1B |
| Example 2 | | | | | | |

Remarks:
AC = acrylic,
EA = ethyl acetate,
NC = nitrocellulose,
TOL = toluene,
MEK = methyl ethyl ketone,
EVA = ethylene vinyl acetate,
IPA = isopropyl alcohol,
VC-VA = vinyl chloride-vinyl acetate,
CAB = cellulose acetate butyrate.

As described above, the colored film according to the present invention has an excellent turbidity. Also, when it is adhered to the windowpanes of cars and buildings, it exhibits excellent ultraviolet blocking effect and flame retardance. In addition, even when glass is broken by impacts from the outside, it can prevent a broken piece of glass from being scattered.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A biaxially stretched, colored polyester film, which comprises:
a transparent polyester layer A;
a colored polyester layer B formed on one surface of the transparent polyester layer A, the colored polyester layer B containing dyes at the amount of 0.01-10% by weight; and
a coating layer C rendered adhesive formed on the surface of the colored polyester layer B opposite to the transparent polyester layer A.

2. The biaxially stretched, colored polyester film of claim 1, wherein at least one of the layers A and B contains an ultraviolet stabilizer at the amount of 0.01-5% by weight.

3. The biaxially stretched, colored polyester film of claim 1, wherein at least one of the layer A and B preferably contains a flame retardant at the amount of 0.01-5% by weight.

4. The biaxially stretched, colored polyester film of claim 1, wherein at least one of the layers A and B preferably contains the ultraviolet stabilizer and the flame retardant, which are added at the amount of 0.01-5% by weight, respectively.

5. The biaxially stretched, colored polyester film of claim 1, which further comprises a pressure sensitive adhesive layer D formed on the other surface of the transparent polyester layer A.

6. The biaxially stretched, colored polyester film of claim 1, which further comprises a deposition layer E formed on the other surface of the coating layer C.

7. The biaxially stretched, colored polyester film of claim 6, which further comprises a pressure sensitive adhesive layer D formed on the other surface of the deposition layer E.

8. The biaxially stretched, colored polyester film of claim 5, which further comprises a transparent film layer F formed on the outer surface of the adhesive layer D.

9. The biaxially stretched, colored polyester film of claim 8, which further comprises a pressure sensitive adhesive layer D formed on the other surface of the transparent film layer F.

10. The biaxially stretched, colored polyester film of claim 7, which further comprises a pressure sensitive adhesive layer D and a transparent film layer F sequentially formed on the other surface of the transparent polyester layer A.

11. The biaxially stretched, colored polyester film of claim 1, wherein at least one of the transparent polyester layer A and the colored layer B contains inorganic particles.

12. The biaxially stretched, colored polyester film of claim 11, wherein the inorganic particles are contained at the amount of 0.01-1% by weight.

13. The biaxially stretched, colored polyester film of claim 11, wherein the inorganic particles have an average particle size of 0.05-5 μm.

14. The biaxially stretched, colored polyester film of claim 11, wherein the inorganic particles are silica.

15. The biaxially stretched, colored polyester film of claim 1, wherein the transparent polyester layer A has a total thickness of 1-10 μm.

16. The biaxially stretched, colored polyester film of claim 1, wherein an adhesive used in rendering the coating layer C adhesive is selected from the group consisting of polyester-, acrylic- and polyurethane-based adhesives, and a combination thereof.

17. The biaxially stretched, colored polyester film of claim 1, wherein the coating layer C has a total thickness of 0.01-1 μm.

18. The biaxially stretched, colored polyester film of claim 2 or 4, wherein the ultraviolet stabilizer is selected from the group consisting of benzophenone-, benzotriazole-, resorcinol monobenzoate-, salicylate-, hydroxy benzoate-, and formamidine-based ultraviolet absorbers, and hindered amine- and imino ester-based ultraviolet stabilizers, and a combination thereof.

19. The biaxially stretched, colored polyester film of claim 3 or 4, wherein the flame retardant is selected from the group consisting of additive-type or reactive-type flame retardants, including alumina trihydrate-, halogen-, phosphorus- and halogenated phosphorus-based flame retardants, and a combination thereof.

20. The biaxially stretched, colored polyester film of any one of claims 1 to 10, which is adapted to adhere on windowpanes of cars or buildings.
